(19) United States
(12) Patent Application Publication
(10) Pub. No.: US 2009/0014119 A1
(43) Pub. Date: Jan. 15, 2009

(54) Process for the Manufacture of Bonded Laid Structures

(75) Inventors: Bernd Wohlmann, Dusseldorf (DE); Andreas Woeginger, Wuppertal (DE)

Correspondence Address: OLIFF & BERRIDGE, PLC, P.O. BOX 320850, ALEXANDRIA, VA, 22320-4850, US

(73) Assignee: Toho Tenax Europe GmbH, Wuppertal (DE)

(21) Appl. No.: 12/223,603

(22) PCT Filed: Feb. 27, 2007
(86) PCT No.: PCT/EP2007/001650

§ 371 Date: Aug. 5, 2008

(30) Foreign Application Priority Data
Mar. 3, 2006 (EP) 06004297.5
Dec. 1, 2006 (EP) 06024883.8

(51) Int. Cl. B29C 65/48

(52) U.S. Cl. 156/272.6

(57) ABSTRACT

A process for manufacturing bonded laid structures from yarns, characterized in that a thermally fusible material is applied to the yarns at least at the contact or intersection points via a thermal spray process and the yarns are subsequently brought together, as well as a process for manufacturing a fiber-reinforced composite material, characterized in that, initially, laid structures according to the invention are manufactured and subsequently, with the addition of further thermally fusible material if necessary, the structures are molded under heat and pressure into the fiber-reinforced composite material.

The invention relates to a process for manufacturing bonded laid structures from yarns, as well as a process for the manufacture of a fiber-reinforced composite material from the same type of laid structures.

On the one hand, flat textile structures such as woven fabric or interlaid scrim are employed for the manufacture of fiber-reinforced composite materials, and, on the other hand, directly laid structures are employed. Flat textile structures are, in general, easy to handle, but they are less well suited for the manufacture of fiber-reinforced composite materials with complex or three-dimensional forms. Laid structures are recommended for this purpose. For example, in DE 201 20 447, yarns are joined in a laid structure, after which a thermally fusible material in powdered form is dispersed, then heated and bonded. In this manner, a preform is produced, which if necessary can be worked further, together with other preforms, into a composite material. This process is suitable only to a limited extent for complex and/or three-dimensional structures, as the only structures that can be manufactured are those in which the yarns remain lying in place after their positioning and do not slip off or together, because the yarns can be held down only to a limited extent during the bonding process using this method.

An additional process for the manufacture of preforms is described in WO 2005/095080 A1, in which the reinforcing yarn is initially impregnated with a thermally fusible material. The yarns are subsequently placed in the laid structure and heated so that the yarns are joined with each other in order to form a bonded, laid structure. Given that even during the laying of the yarns, which are also employed in a flat form, for example in the form of a flat band (tape), the thermally fusible material for the impregnation can be at least superficially melted and that consequently, even during the yarn placement, adjacent or intersecting yarns can be joined by the bonding of the melted material, complex and/or three-dimensional structures can be produced according to this process. Still, the entire process described therein is very time consuming.

The object of the present invention is therefore to provide a process for manufacturing bonded laid structures from yarns, by which means complex and/or three-dimensional structures can also be produced directly in a relatively short time period. In addition, it is the object of the present invention to provide a process for the manufacture of fiber-reinforced composite materials by using the same type of laid structures produced according to the invention.

This object is achieved by a process for the manufacture of bonded laid structures from yarns, during which process a thermally fusible material is applied to the yarns, at least at the contact or intersection points, via a thermal spray process. The yarns are subsequently brought together while the thermally fusible material, applied via a thermal spray process, is still in a plastic or molten state.

The term “thermal spray process” is defined in DIN 657:2005. In this standard, various spray processes are summarized, which are then classified according to the type of spray additive, the production, and/or the energy source. Of these thermal spray processes, the methods are particularly preferred that melt the thermally fusible material and shoot the material, preferably in the form of tiny droplets, onto the laying body and/or the yarn, preferably at a high velocity. The laying body is either a form approximating the final form or a layer which is already laid on this form.

Exactly controlled, metered amounts of the plasticized, preferably still molten, thermally fusible material can be applied to the yarns by these thermal spray processes. In this respect, it is possible, using the process according to the invention, to control the application of the plasticized, preferably still-molten thermally fusible material in regard to application quantity such that, on the one hand, a good bonding between adjacent yarns is guaranteed and, on the other hand, the required cooling phase for the bonding of the plasticized, preferably still-molten thermally fusible material is reduced.

The process according to the invention has proven itself in particular when the thermally fusible material is applied with a powder via thermal spraying, whereby the powder is the thermally fusible material. The necessary quantity of molten thermally fusible material is applied in a very short time using this method in order to bind one yarn with another yarn at their contact and/or intersection points.

This process has especially proven itself when a plasma jet is used as the energy source.

For the manufacture of the laid structures according to the invention, thermally fusible material of a type should be used that demonstrates good adhesion with the material to be used for the manufacture of the fiber-reinforced composite material. Suitable materials include practically all materials that are used as the matrix for composite materials and are thermally fusible. In particular, these include aliphatic polyamides, aromatic polyamides, thermoplastic polyimides, polyarylene ether sulfones, polyarylene ether ketones, polyphenylene sulfides, polybenzimidazoles, liquid crystalline polymers, and duromers having thermoplastic behavior. For the thermal spraying, it is preferable to use polymers that are similar to, in particular the same polymers as, those that will also be used later as the matrix for the composite material. Between the individually laid layers, layers can also be applied that enable particular functions such as halting tear propagation in the case of a failure. Practically all yarns that are suitable for the manufacture of fiber-reinforced composite materials can be considered for use as the yarns. Glass, quartz, aramid, silicon carbide or carbon fibers are most suitable.

The process according to the invention is characterized as particularly advantageous when the yarns are coated with the thermally fusible material over their entire length by the thermal spraying during the laying process.

It has also been demonstrated as advantageous if yarns are used that have already been coated with a thermally fusible material. In particular, such yarns can be used that have been impregnated with a thermally fusible material. The impregnated yarns described in WO 2005/095080 A1 are most suitable for this.

Of the coated or impregnated yarns, the ones that have demonstrated themselves as particularly advantageous are those that have a very flat form and in this respect are in the form of a tape. Yarns of this type are described for example in EP 0 937 560, EP 1 281 498, and U.S. Pat. No. 4,900,499.

The method according to the invention succeeds superbly when the material to be applied via thermal spraying is a material with a thermoplastic behavior, or preferably is a thermoplastic material.

The object according to the invention is also achieved by a process for the manufacture of a fiber-reinforced composite material, which is characterized in that, initially, laid structures according to the invention are manufactured and subsequently, with the addition of further thermally fusible material if necessary, the structures are molded under heat and pressure into the fiber-reinforced composite material.

It is preferred that the fusible material used for the thermal spraying, the fusible material used if necessary for coating or impregnating the yarns, and the fusible material used for manufacturing the composite body consist of similar polymers, in particular of the same polymers.

1. A process for the manufacture of bonded laid structures from yarns, wherein a thermally fusible material is applied to the yarns at least at the contact or intersection points via a thermal spray process and the yarns are subsequently brought together while the thermally fusible material, applied via the thermal spray process, is still in a plastic or molten state.

2. A process according to claim 1, wherein the thermally fusible material is applied with a powder via thermal spraying, whereby the powder is the thermally fusible material.

3. A process according to claim 1, wherein a plasma jet is used for the energy source.

4. A process according to claim 1, wherein the yarns coated over their entire length by thermal spraying with the thermally fusible material during the laying process.

5. A process according to claim 1, wherein yarns are used that are already coated with a thermally fusible material.

6. A process according to claim 1, wherein yarns are used that are already impregnated with a thermally fusible material.

7. A process according to claim 5, wherein the yarns are in the form of a tape.

8. A process according to claim 1, wherein the material to be applied via thermal spraying is a material that has a thermoplastic behavior.

9. A process according to claim 1, wherein the material to be applied via thermal spraying is a thermoplastic material.

10. A process for the manufacture of a fiber-reinforced composite material, wherein, initially, laid structures are manufactured according to the process according to claim 1 and subsequently, with the addition of further thermally fusible material if necessary, the structures are molded under heat and pressure into the fiber-reinforced composite material.

11. A process according to claim 9, wherein the fusible material used for the thermal spraying, the fusible material used if necessary for coating or impregnating the yarns, and the fusible material used for manufacturing the composite body consists of similar polymers.

12. A process according to claim 10, wherein the fusible material used for the thermal spraying, the fusible material used if necessary for coating or impregnating yarns, and the fusible material used for manufacturing the composite body consist of the same polymers.
